(19) United States
(12) Patent Application Publication
(10) Pub. No.: US 2010/0047158 A1
(43) Pub. Date: Feb. 25, 2010

(54) METHOD AND REACTOR FOR PRODUCTION OF HYDROGEN

(75) Inventors: Borre Borresen, Tiller (NO); Erling Rytter, Trondheim (NO); Ingrid Aartun, Frekhaug (NO); Bente Krogh, Vikhammer (NO); Morten Ronnekleiv, Trondheim (NO)

Correspondence Address: VOLPE AND KOENIG, P.C., UNITED PLAZA, SUITE 1600, 30 SOUTH 17TH STREET, PHILADELPHIA, PA, 19103, US

(73) Assignee: STATOILHYDRO ASA, Stavanger (NO)

(21) Appl. No.: 12/532,222

(22) PCT Filed: Mar. 18, 2008
(86) PCT No.: PCT/NO08/00111

§ 371 Date: Oct. 13, 2009

(30) Foreign Application Priority Data
Mar. 19, 2007 (NO) 20071464

(51) Int. Cl. C01B 3/02; C01B 3/38; B01J 8/18

(52) U.S. Cl. 423/648.1; 252/373; 422/141; 422/145

(57) ABSTRACT

A method for production of hydrogen including reforming of a carbon comprising fuel is provided together with production plants adapted for obtaining hydrogen at lower temperatures and/or higher pressures and obtaining a CO₂ rich rest gas stream. A reformer and a water gas shift reactor are also provided.

The present invention relates to a method and plants for hydrogen production from a carbon comprising fuel. Further the invention relates to a reformer for reforming a carbon comprising fuel, a water gas shift reactor and a method for production of hydrogen from syngas.

Hydrogen production is conventionally performed by steam reforming (SR). Autothermal reforming (ATR) is also an option, especially connected to large scale capacity. The steam reforming reaction is highly endothermic, and the heat required for the reaction may be obtained either through external heating or by combining steam reforming with the exothermic partial oxidation in an autothermal reformer. Such reformers are common technology for processing of hydrocarbon feeds such as natural gas. In both cases one or more catalyst are conventionally used to enhance the reactions.

The main reactions that are involved if the fuel is methane are for steam reforming reaction (1) and for autothermal reforming reaction (1)+(2) as follows:

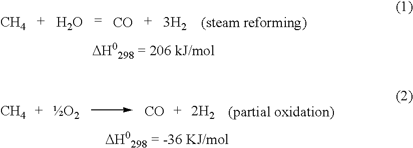

In both cases the water gas shift (WGS) reaction (3) is also important:

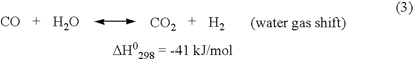

Industrially, hydrogen production is typically conducted at 900-1000° C. generated with external heating in SR and internal combustion heating in ATR. These technologies, in particular due to the high temperatures, lead to high investments, operational costs and a number of challenges which include: Investment costs for materials which are corrosion resistant at such high temperatures. Investments in high heat exchange capacity which is required in order to cool the waste gas and utilize the energy therein. There is a risk of metal dusting in the heat exchanger due to typical temperature in the area 500-700° C. and high partial pressure of CO. In steam reforming up to 30% of the fuel is combusted in an external burner, and the heat must be transported into the catalyst. Energy is also needed to heat the feed gases, including steam, to the reaction temperature. Water gas shift reactor(s) are usually installed after the reformer to obtain a higher yield of hydrogen. Hydrogen production with SR and ATR require separation of hydrogen from the produced syngas comprising CO, CO₂, CH₄ and H₂. This can for instance be obtained by pressure swing adsorption (PSA).

Today there is a high focus on the environmental consequences of the release of carbon dioxide into the atmosphere, and its relationship with increased greenhouse effect and global warming. There is a great interest in methods for hydrogen and/or power production without CO₂ emissions.

If CO₂ should be captured from hydrogen production after a conventional steam or autothermal reformer, the additional process step will require a lot of energy, up to 30% of the lower heating value (LHV) of the hydrogen produced. For a SR the very low partial pressure of CO₂ in the burner exhaust gas, will require an additional CO₂ capture step.

EP 1061039, JP 6321503 and EP 867404 disclose different apparatus for separation of hydrogen from syngas obtained by a reforming process comprising hydrogen permeable membranes.

Further JP 57145001 describes the construction of a hydrogen storage where hydrogen can be stored in the form of a metal hydride. The reactor is especially constructed with respect to utilising the formation heat from the formation of metal hydride. The publication does not describe methods for production of hydrogen.

U.S. Pat. No. 4,769,225 disclose a process which comprises a selective reaction between hydrogen and particles comprising compounds able to form metal hydrides. The reactions take place in a slurry of particles. Absorption of hydrogen from a mixture comprising hydrogen and carbon dioxide is disclosed. The gas mixture is supplied from the outside. Absorption takes place at a temperature of about 30° C. and a pressure of 7-10 atm.

US 2005/229488 describes a reforming process which takes place in a reactor comprising a carbon dioxide fixing material, thereby creating a hydrogen-rich reformate. During the reforming process carbon dioxide is retained by the carbon dioxide fixing material. The publication describes that it is possible to utilise the heat from a hydrogen storage system for heating of the reforming process, by heat exchanging the feed gas with the hydrogen storage system.

JP 62279264 discloses a reformer heated by the exhaust from an engine. The reformed gas is supplied to the engine as part of the fuel. A metal hydride is connected to the reformer via a palladium group separation film. The aim of the film is to protect the metal hydride. The metal hydride functions as a hydrogen storage. The hydrogen is supplied to the engine as part of the fuel. The metal hydride is not in direct contact with the reformed gas. Only one common exhaust gas stream is formed. This stream comprises both nitrogen and carbon dioxide.

U.S. Pat. No. 4,675,465 describes in-situ formation of metal hydride during a dehydrogenation reaction. The aim of the reaction is to drive otherwise thermodynamically unfavourable dehydrogenation reactions at moderate temperature conditions.

The aim of the present invention is to provide a method for the production of hydrogen which can proceed at a lower temperature than the traditional processes. The goal is also to provide a process which may generate heat in-situ for the endothermic steam reforming reaction and thus lower the need for external heat supply or oxygen for internal heat supply to the reforming process. The aim is also to provide a process which will lead to a high conversion at a relatively low temperature. The process should further preferable be adaptable to efficient separation of CO₂.

A further object of the present invention is to provide a compact system for the production of hydrogen adaptable for more efficient separation of CO₂. It is also an aim to provide a compact unit for the production of hydrogen and a plant adapted for comprising said unit.

It has now been realised that these and other goals can be obtained by performing a steam or autothermal reforming process in the presence of a hydrogen sorption material, i.e. a hydrogen adsorbing/absorbing substance.

The present invention provides a method for production of hydrogen comprising reforming of a carbon comprising fuel thereby obtaining syngas, characterised in that said method comprises
bringing the syngas in contact with a hydrogen sorption material,
ab-/adsorbing hydrogen in the hydrogen sorption material,
forming a CO₂ rich rest gas stream, and
desorbing hydrogen from said hydrogen sorption material,
   where the ab-/adsorbing of hydrogen enhances the production of hydrogen and carbondioxide.

Further the present invention provides a hydrogen production plant, characterised in that the plant comprises at least one hydrogen sorption water gas shift reactor comprising a water gas shift catalyst and a hydrogen sorption material, wherein said hydrogen sorption water gas shift reactor comprises a syngas inlet, a rest gas/hydrogen outlet or a rest gas and a hydrogen rich sorption material outlet and optionally a sorption material inlet.

Another aspect of the present invention is a hydrogen production plant characterised in that the plant comprises at least one hydrogen sorption reformer comprising a hydrogen sorption material and a reforming catalyst wherein said reformer comprises one or more inlets for carbon comprising fuel, steam and optionally a oxygen comprising stream, and optionally a sorption material inlet; a rest gas/hydrogen outlet or a rest gas and a hydrogen rich sorption material outlet.

The present invention also provides a reformer comprising one or more inlets for carbon comprising fuel, steam and optionally an oxygen comprising stream, characterised in that the reformer comprises a hydrogen sorption material and a reforming catalyst wherein said reformer comprises a rest gas/hydrogen outlet or a rest gas outlet and a hydrogen rich sorption material outlet.

Further the present invention provides a water gas shift reactor comprising a water gas shift catalyst and a syngas inlet characterised in that said reactor comprises a hydrogen sorption material and wherein the reactor comprises a rest gas/hydrogen outlet or a rest gas outlet and a hydrogen rich sorption material outlet.

Yet another aspect of the present invention is a method for production of hydrogen from syngas, characterised in that the method comprises
bringing the syngas in contact with a hydrogen sorption material, in proximity of a water gas shift catalyst,
ab-/adsorbing hydrogen in the hydrogen sorption material,
forming a CO₂ rich rest gas stream, and
desorbing hydrogen from said hydrogen sorption material.

In this aspect of the invention the temperature during the sorption is in the range 100 to 600° C., preferably 200 to 550° C., more preferably between 250 and 500° C., and the pressure during the sorption is between 2 and 150 bar, preferably between 15 and 80 bar, more preferably between 20 and 50 bar.

Other embodiments of the present invention are described in the sub-claims.

The present invention is based on the use of a hydrogen absorbing/adsorbing material for combining several processes in one reactor, thereby achieving more favourable conditions and a more compact system.

A conventional reforming plant comprises reformer, one or more water gas shift (WGS) reactors and a pressure swing absorption (PSA) unit.

In one aspect of the present invention the reforming plant according to the present invention comprises a reformer and a hydrogen sorption enhanced water gas shift (HSEWGS) reactor unit, wherein the HSEWGS comprises a hydrogen sorption material and water gas shift catalyst. According to this aspect of the invention the HSEWGS unit replaces both the WGS and the PSA units.

In another aspect of the present invention the reforming plant according to the present invention comprises a hydrogen sorption enhanced reformer (HSER) reactor unit, wherein the HSER comprises a reforming catalyst, a hydrogen sorption material and optionally a water gas shift catalyst. According to this aspect of the invention the HSER unit replaces both the reformer, the WGS and the PSA.

A hydrogen absorbing/adsorbing substance according to the present invention is a substance or compound capable of selectively and reversible absorbing hydrogen and thereby lowering the hydrogen partial pressure, which will result in the formation of more hydrogen according to the reactions (1), (2) and (3). Accordingly the reactions are driven by the removal of available hydrogen and the equilibriums are shifted to the right towards hydrogen and carbon dioxide. By continuously removal of hydrogen from the reaction mixture it is possible to obtain sufficient conversion at a lower temperature than normally.

The fuel used in the present invention is a carbon comprising fuel, i.e. hydrocarbons, as natural gas, Liquefied Petroleum Gas (LPG), gasoline, diesel, biogas etc; alcohols or biomass etc.

The term “syngas” is used in this context to refer a gas comprising hydrogen and carbondioxide and to some extend carbonmonooxide and H₂O. However the gas may also comprise other compound such as nitrogen, oxygen, uncombusted fuel and inert gas etc.

The term “reforming catalyst” is used in this context to refer to any agent or substance able to catalyse the steam and/or autothermal reforming reactions in the direction towards the production of hydrogen.

The term “water gas shift catalyst” is used in this context to refer to any agent or substance able to catalyse the water gas shift reaction in the direction towards the production of hydrogen.

By removing hydrogen in the proximity of one or more hydrogen producing reactions, the equilibrium could be shifted towards hydrogen production and thus lead to high conversion at a relatively low temperature.

Another advantage of the present invention is that by removing hydrogen by sorption, the CO₂ capture can be easier and less energy demanding since the partial pressure of CO₂ will be higher after a sorption enhanced process (reforming or water gas shift) as the hydrogen can be removed without lowering the pressure of the rest gas, unlike what is the case of a PSA. In a PSA, all gases but hydrogen are adsorbed so that hydrogen will be recovered at close to reaction pressure while the rest gas will be desorbed at lower pressure, typically atmospheric pressure. CO₂ will thus be present at high pressure but relatively low concentration before the PSA and at higher concentration but low pressure after the PSA.

A further improvement compared to conventional technology may be that hydrogen can be recovered at high pressure by desorbing the hydrogen by elevation of the temperature, i.e. using the hydrogen sorbent as a solid state compressor.

The present invention will be described in further detail with reference to the enclosed figures where:

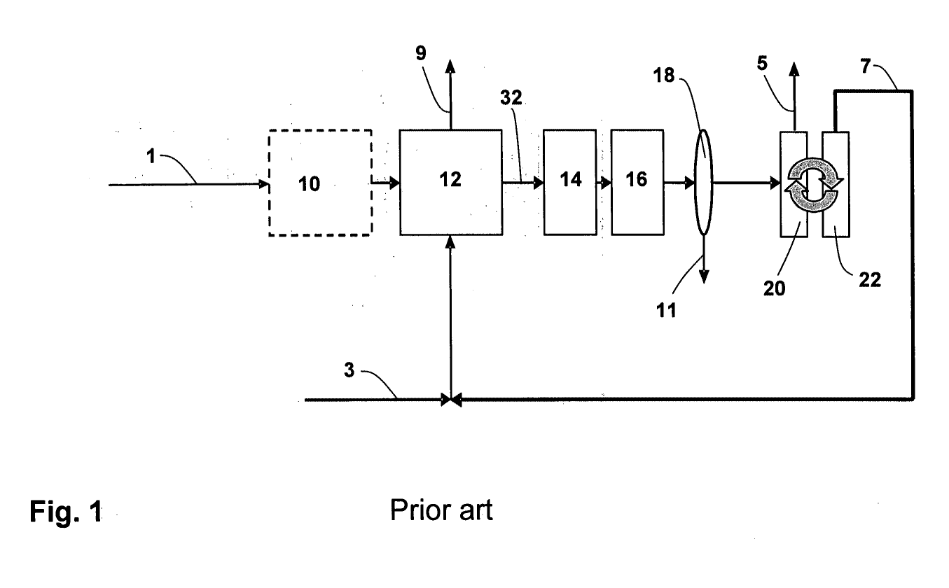

FIG. 1: illustrates the prior art on this field;

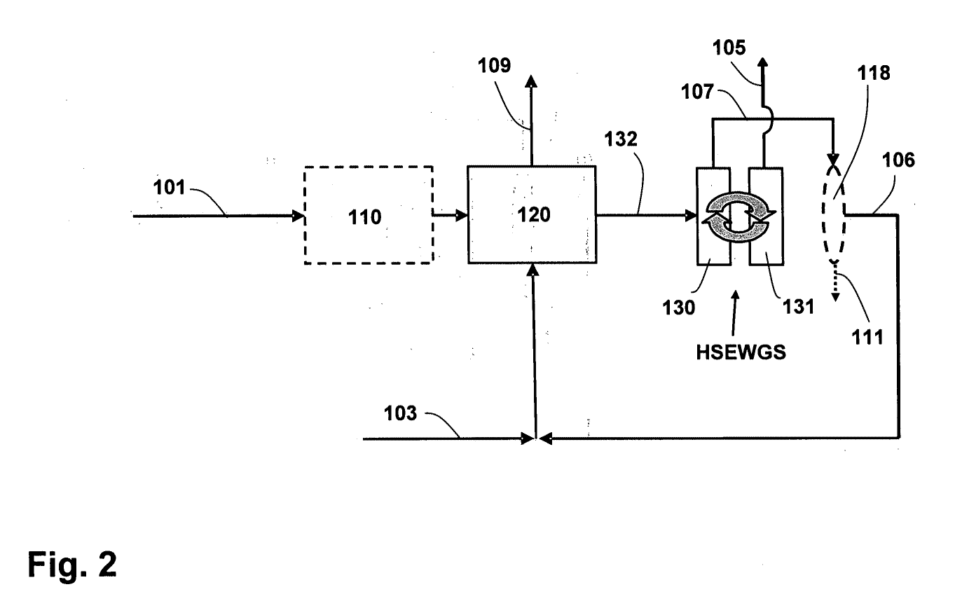

FIG. 2: illustrates a first embodiment of the present invention;

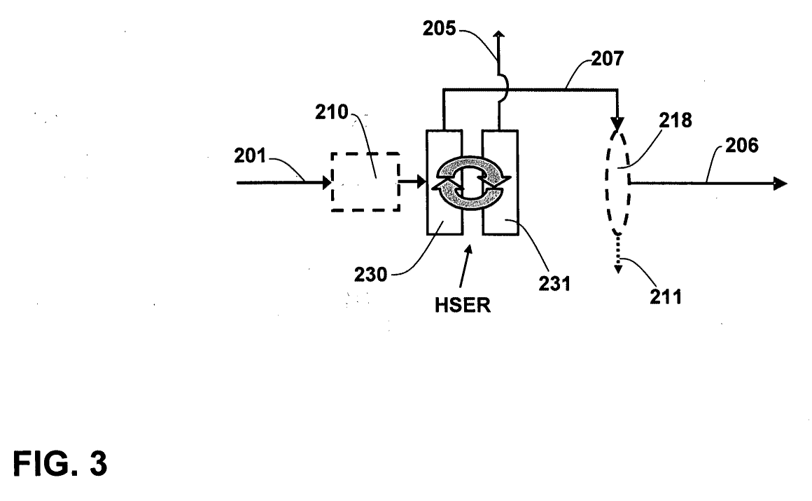

FIG. 3: illustrates a second embodiment of the present invention;

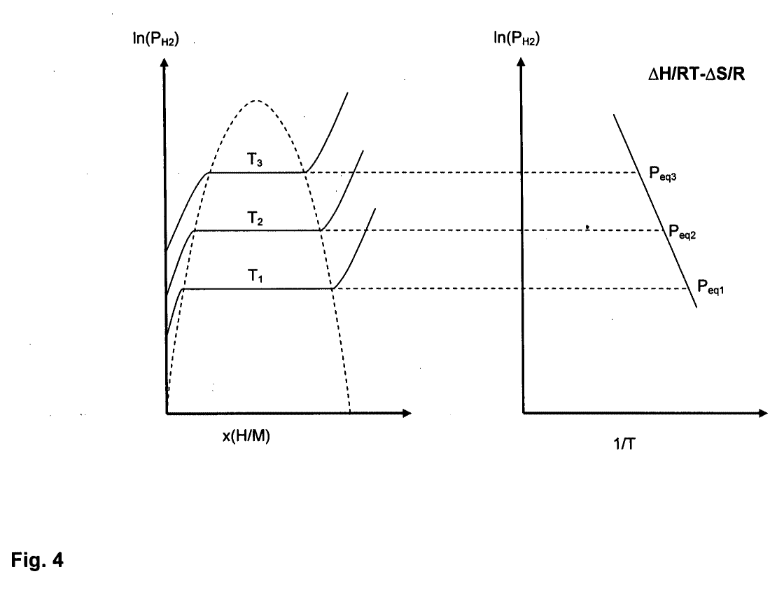

FIG. 4: shows a typical PCT curve for a metal hydride;

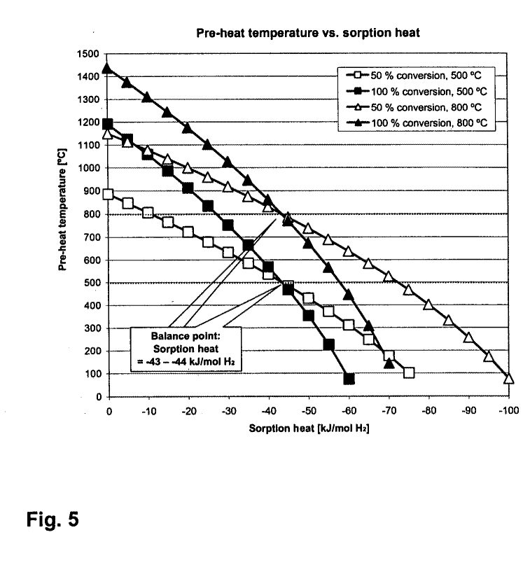

FIG. 5: shows the pre-heat temperature needed to assure an outlet temperature of 500° C. or 800° C. in an adiabatic reactor using a hydrogen sorbent with varying sorption heat. Steam/C=3. Hydrogen recovery is 95%;

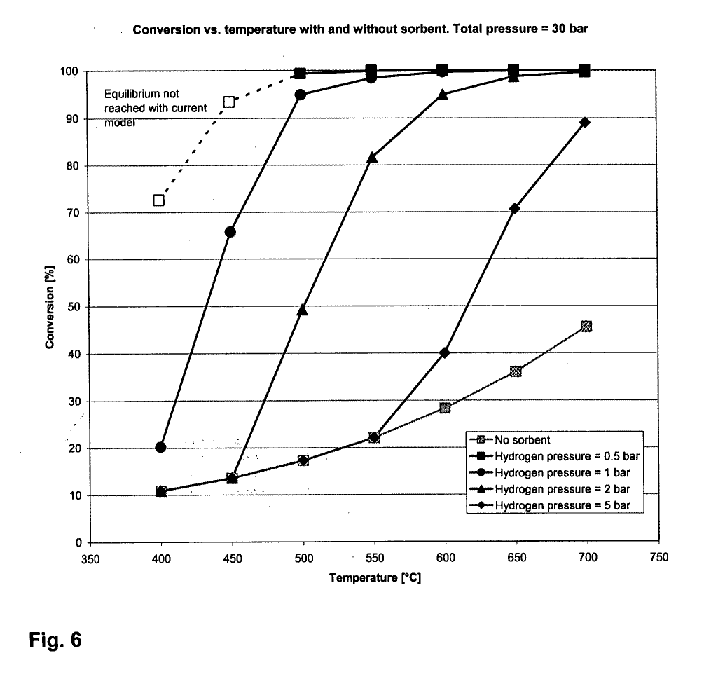

FIG. 6: shows the conversion vs. temperature with and without sorbent. The total reaction pressure is 30 bar and steam/C=3;

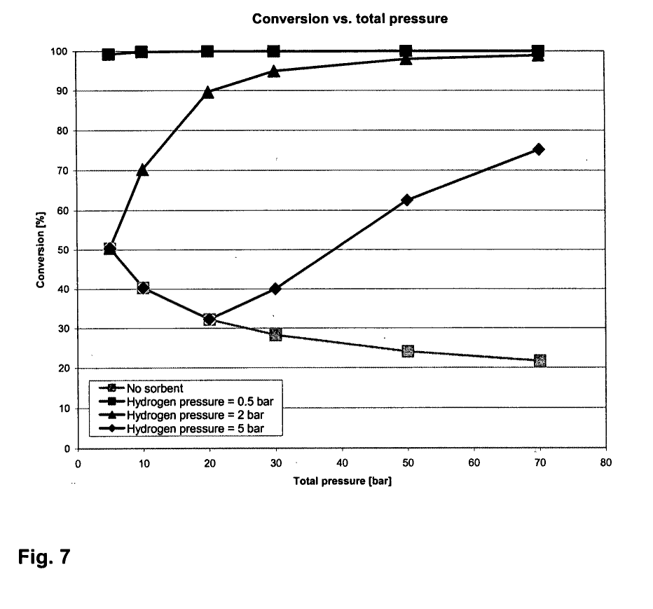

FIG. 7: shows the conversion vs. total pressure with and without sorbent. The reaction temperature is 600° C. and steam/C=3.

FIG. 1 shows a system for hydrogen production by steam reforming of hydrocarbons according to the prior art. Such a system may consist of a pre-reformer 10 (depending is on the fuel); a conventional tubular steam reformer 12 followed by high and low temperature water-gas shift reactors 14 and 16, and a PSA (Pressure Swing Adsorption) 20, 22 for hydrogen purification. Steam and hydrocarbon fuel is feed into the system trough conduit 1. The system further comprises a condenser 18 or a similar unit for the removal of water 11. Tubular steam reformers are prior art and applied in many plants for processing of hydrocarbon feeds, e.g. in production of methanol, ammonia or hydrogen itself.

In the prior art system according to FIG. 1 a hydrogen rich stream 5 is obtained at close to reaction pressure (typically 20-40 bar) from the PSA 20, 22. The rest gas 7, which is obtained at a low pressure (typically atmospheric), is in this prior art illustration used as fuel for heating the tubular reformer 12. Air and possible additional fuel is added via conduit 3. The exhaust gas 9 will primarily comprise carbon dioxide, water and nitrogen.

A similar prior art system as the one illustrated on FIG. 1, but based on ATR would comprise an autothermal reformer in stead of the tubular reformer and be fed with fuel comprising hydrogen and carbon. The reformer would further comprise a separate oxygen and /or air inlet for reaction (2) to take place.

One of the challenges of the above described process and other fuel reforming processes as partial oxidation and autothermal reforming is the reversible nature of SMR (steam methane reforming) and WGS (water-gas shift) reactions which present equilibrium limitations on the purity of the product streams. These reactions can be driven towards the products by removing one of the products (e.g. hydrogen) from the reaction system as soon as it is formed. One important benefit of this removal of hydrogen is that the reaction temperature in the reformer can be lowered while still maintaining a similar conversion leading to several advantages for the processes and equipment. If the temperature can be lowered under 650° C., preferably below 600° C. and more preferably below 550° C., less expensive alloys can be used in the construction of reactors and associated equipment. In addition, material problems caused by corrosion processes like metal dusting can be reduced or avoided. At this low temperature, the amount of heat needed to warm up the reactants to the reaction temperature will be significantly lowered, meaning higher energy efficiency as well as reduction in heat exchanger area needed in the reforming processes.

One option for removing hydrogen from the reaction zone that has been described is to use a hydrogen permeable membrane, which has earlier been described in several patents (e.g. CA 2,556,280; CA 2,554,622). The main advantages with an integration of a hydrogen selective membranes into the reactor are that the shift of the chemical equilibrium allows for a reduced operation temperature without loosing the rate of conversion as well as that the reforming process and the purification of hydrogen are integrated and occur at the same time. However, it has turned out that there are significant technical challenges with such membranes. If one uses a porous membrane, the hydrogen will inadvertently contain a portion of molecular species containing carbon atoms. In addition, the stability issue of such membranes operating at elevated temperature and in a gaseous atmosphere containing steam has not been solved. Solid membranes operate either at very high and unfavourable temperatures, typical of proton conducting membranes, or with thin layers of a precious metal, typically palladium. The latter type of membranes tends to be expensive and it is as yet not proven that they can be stable under normal industrial conditions over years of operation.

We are proposing that the benefit of removing hydrogen from the reaction mixture can be achieved in a different and simpler way, namely by a sorption enhanced reaction. In this method, hydrogen is trapped by a solid material present in the reactor, either by physical adsorption to the surface of a porous compound, chemical adsorption or by absorption, i.e. bound internally in the solid sorption material. Hydrogen can be released by lowering the pressure and/or increasing the temperature of the hydrogen comprising sorbent. The hydrogen sorption enhanced method can be applied to processes where hydrogen is the main or in part the product, or where production of the desired product is facilitated by removing hydrogen. Such processes include steam reforming, autothermal reforming, shift conversion and dehydrogenation.

Sorption enhanced reactions are not a novel concept in itself as this has been used to remove CO₂ from the gaseous reaction mixture in steam reforming or shift reaction. Used in this way, the hydrogen produced will comprise residual CO₂ in addition to unconverted methane, CO and steam. It is also known that hydrogen sorption materials have been investigated previously, but for the purpose of storing hydrogen, typically combined with hydrogen fuel cells in vehicles.

A very important improvement of this invention compared to today's technology is that CO₂ capture can be easier and less energy demanding since the partial pressure of CO₂ will be higher after a sorption enhanced process (e.g. reforming or water gas shift) as the hydrogen can be removed without lowering the pressure of the rest gas, unlike what is the case of a PSA. The rest gas would in addition to CO₂ also comprise small amounts of other compounds, e.g. steam, CO, H₂ and methane if used in steam reforming or water gas shift. This rest gas could in some processes be burned in order to generate heat and/or steam to other parts of the overall process.

FIG. 2 shows an embodiment of the present invention. A feedstock 101 comprising fuel and in the case of SR steam is optionally introduced to a pre-reformer 110, or directly into a reformer 120. The reformer may have any applicable configuration. If the reformer is an ATR it comprises a separate oxygen and/or air inlet directly to the reformer, not shown on FIG. 2. The reformer generates a syngas stream 132 which is fed into a Hydrogen Sorption Enhanced Water Gas Shift (HSEWGS) reactor unit 130. The sorption reactor comprises water-gas shift catalysts in combination (mixed or layered in any possible way) with a suitable hydrogen sorption material. The absorbent or adsorbent is described in further detail below. The sorbent can be in any convenient form that is suitable for deployment in the reactor, e.g. as powder, pellets, extrudates, pills etc., or mixtures thereof. It could also act as a support for the water gas shift catalysts or vice versa. The catalysts/sorbent bed could comprise a mixture of the components or divided in a first, second etc. bed with catalyst first and sorbent secondly or any other combination which is complying with the process demands. In the reactor unit 130 hydrogen present in the syngas is bound by the sorption material and this together with effect of the water gas shift catalyst shifts the equilibrium of the reactions towards a higher hydrogen yield. The rest gas 107 will be depleted from hydrogen and comprise mainly CO₂, H₂O and any unreacted fuel. In one embodiment of the present invention this rest gas is past through an optional condenser 118 or similar unit for optional removal of water 111. The thereafter obtained rest gas 106 can optionally as illustrated be used for heating the reformer 120 by introducing oxygen or air or a mixture thereof 103 and burning any unreacted fuel and remaining hydrogen. If necessary additional fuel may be added to obtain the desired temperature. An exhaust gas 109 comprising all the generated CO₂ is obtained. In this embodiment the HSEWGS comprises a second unit 131 from which hydrogen 105 is desorbed advantageous at elevated pressure. The second unit 131 can either be a HSEWGS reactor in which case the reactors will run as illustrated until the reactor 130 is not able to ab-/adsorb more hydrogen or no more hydrogen may be desorbed from reactor 131, at which point the streams will be redirected so that reactor 131 functions as sorption reactor whereas hydrogen is desorbed from reactor 130. Alternatively the sorption material may continuously or batch wise be removed from the HSEWGS reactor 130 into a desorption reactor 131. I both cases heat and/or low pressure may be applied to enhance the desorption.

The benefits of the HSEWGS compared to the conventional prior art scheme in FIG. 1 are evident. In this more compact system configuration the two shift reactors and the PSA is replaced with one HSEWGS reactor unit. Apart from removing several process units, it is seen that the hydrogen can be extracted at an elevated pressure for subsequent use or storage. In addition, the partial pressure of CO₂ in the rest gas will be higher than both before and after the PSA in the prior art process, and CO₂ could therefore be captured easier and with less energy penalty. If this rest gas is used as a fuel for the tubular reformer, pressurized combustion could be an option to retain the advantage of a high CO₂ partial pressure.

FIG. 3 shows another embodiment of the present invention. Here a fuel and optionally steam comprising stream 201 is optionally introduced to a pre-reformer 210 before it is fed to a Hydrogen Sorption Enhanced Reformer (HSER) reactor 230. If the reformer is an autothermal reformer the reformer further comprises a separate oxygen and/or air inlet, not shown on FIG. 3. The reactor comprises reformer and optionally separate water-gas shift catalysts in combination (mixed or layered in some way) with a suitable hydrogen sorbent, i.e. a metal hydride. The hydrogen absorbent/adsorbent may be in the form of a powder, pellets or a mixture thereof. It could also acts as support for the reformer or/and water gas shift catalysts or vice versa. The catalysts/ab(ad)sorbent bed could comprise a mixture of the components or divided in a first, second etc. bed with one of the catalysts first and ab(ad)sorbent secondly or other combinations which suits the process demands. In the reactor 230 hydrogen generated by steam reforming of the fuel under influence of the reforming catalyst is bound by the sorption material and this together with the optional effect of the water gas shift catalyst shifts the equilibrium of the reactions towards a higher hydrogen yield. The rest gas 207 will be depleted from hydrogen and comprise mainly CO₂, H₂O and any unreacted fuel. In one embodiment of the present invention this rest gas is optionally past through a condenser 218 or similar unit for optional removal of water 211. The thereby a dried rest gas 206 is obtained. In this embodiment the HSER comprises a second unit 231 from which hydrogen 205 is desorbed at elevated pressure. The second unit 231 can either be a HSER reactor in with case the reactors will run as illustrated until the reactor 230 is not able to ab-/adsorb more hydrogen or no more hydrogen may be desorbed from reactor 231, at which point the streams will be redirected so that reactor 231 functions as sorption reactor whereas hydrogen is desorbed from reactor 230. Alternatively the sorption material may continuously or batch wise be removed from the HSER reactor 230 into a desorption reactor 231. I both cases heat and/or low pressure may be applied to enhance the desorption.

As evident when comparing FIG. 3 with FIG. 1 this embodiment provides an even more compact system configuration where the reformer, two shift reactors and PSA is replaced by one HSER reactor unit.

If the method according to one aspect of the present invention the oxygen needed during reforming and/or combustion processes may be supplied by any applicable method including by chemical looping or oxygen ion transport.

When performing a method for according to the present invention the temperature during the sorption is in the range 100 to 1000° C., preferably 200 to 800° C., more preferably between 300 and 650° C., even more preferably between 350 and 550° C. The pressure during the sorption is between 2 and 150 bar, preferably between 15 and 80 bar, more preferably between 20 and 50 bar.

When performing a method for according to the present invention the temperature during the desorption is 10-400° C. above the temperature during the sorption, preferably between 50 and 250° C. above. In this case the partial pressure of hydrogen may be higher than during the absorption step. The partial pressure of hydrogen during the desorption may be lower than during sorption, preferably less than 50%, more preferable less than 20% of the pressure during sorption. If variation in pressure is used to control the sorption/desorption process, the pressure during desorption must be lower than the partial equilibrium pressure of hydrogen during the sorption step. The lower the partial pressure of hydrogen is during desorption the more hydrogen will be released. Typical the pressure should be less than 1 bar.

Hydrogen Absorption/Adsorption Materials

Examples of possible hydrogen absorbing/adsorbing materials comprise but are not limited to metal hydride forming metals and metal alloys, functionalised micro porous materials for instance of the zeolite type, metal organic structures, functionalised porous polymers such as crosslinked polystyrene as well as organic and inorganic materials which can be hydrogenated and similar. The most important property of the hydrogen absorbing/adsorbing material is its ability to extract hydrogen from a gas mixture in a hydrogen producing reactor and store the extracted hydrogen under these conditions. Further the extraction and storing must be reversible so that the hydrogen product is is formed when the extracted hydrogen is released. Further it should be possible to reuse the absorbing/adsorbing material either directly or after a regeneration process.

The metal hydride alloy is preferably selected from the group consisting of Ti based alloys, rare earth metal alloys, Ni-base alloys or Mg based alloys. The material may be protected by a suitable hydrogen permeable coating in order to enhance the tolerance to impurities like water, sulphur and oxygen.

An example of a metal hydride that could be used as hydrogen absorbent in sorption enhanced systems is Mg-Ni alloys. Many groups around the world are working with Mg based alloys for hydrogen storage usage since magnesium has good gravimetric (˜7.6 wt-%) and volumetric efficiency (˜150 kg H₂/m³), low cost and abundance on the earth. Drawbacks as slow kinetics are overcome by the additions of various compounds (metal, transition metal, oxides etc.) and use of mechanical grinding and reactive milling in hydrogen atmosphere (nano-composites). Mg₂Ni is found to absorb ˜3 wt % hydrogen to form Mg₂NiH₄ at temperature ˜230° C. and hydrogen partial pressure of ˜0.4 bar. Desorption can take place by increasing the temperature to around 200° C. above absorption temperature. At 420° C. the corresponding desorption pressure of hydrogen would reach 35 bars. See A. Reiser et al., hit. J. of Hydrogen Energy 25 (2000) 425-430. This temperature and pressure values fits well with the required process conditions given in a steam reforming system for production of hydrogen where WGS and PSA is replaced by HSEWGS. The high pressure, high purity hydrogen released under the regenerating is beneficial for further processing.

Another example of a possible metal hydride to use as hydrogen absorbent in sorption enhanced systems is Ti—Cr alloy. TiCr_{0.05} is found to absorb 1-2.5 wt % hydrogen to form TiCr_{0.05}Hₓ at temperatures around 600-800° C. and hydrogen partial pressure of 0.5-1 bar. Desorption can take place by increasing the temperature, and at 200° C. above absorption temperature (800-1000° C.) the corresponding desorption pressure of hydrogen would reach 1-8 bars, see S. Ishiyama et al., Journal of Alloys and Compounds 231 (1995) 895-897. These temperature values fit with the required process conditions in steam reforming for hydrogen production where both reformer, WGS and PSA is replaced by a HSER. The desorption pressure is somewhat lower than desired. Research on modification of the suitable materials, e.g. by adding various component/compounds, could lead to discovery of hydrogen absorbent materials with even higher desorption pressure for use in this temperature regime. For use of high purity hydrogen in fuel cell applications, however, high pressure is not needed.

Reaction/Hydrogen Sorption Step:

The sorbent can be either an absorbent or a chemical or physical adsorbent. Hydrogen sorption (e.g. in hydride forming materials) are typically exothermic reactions, where the heat released is a measure of the binding energy between hydrogen and the matrix material. For different metal hydrides there is typically a correlation between the plateau pressure (equilibrium pressure of hydrogen over the hydride) and the heat of sorption.

A typical PCT (pressure ln(P_{H2}), composition x(H/M), temperature 1/T) curve for a metal hydride M is given in FIG. 4. The plateau/equilibrium pressure P_{eq1}, P_{eq2} and P_{eq3} is the flat part of the isotherms at T₁, T₂, and T₃ where more hydrogen can be absorbed without elevation of the partial pressure of hydrogen. For a given metal hydride M the plateau pressure is dependent on the temperature. An efficient utilisation of a material as a sorbent in the described systems require a material which has a lower equilibrium pressure of hydrogen than the partial pressure of produced hydrogen at the operating temperature in order to achieve any significant sorption of the produced hydrogen.

Regenerating/Desorption Step:

After a certain amount of hydrogen has been absorbed the reactor needs to be regenerated to release hydrogen by increasing the temperature or lowering the hydrogen partial pressure. The needed temperature is dependent on the desired pressure of the produced hydrogen. Heat could be supplied in two ways; by external or internal heat supply. Heat can be supplied internally for example by feeding a small amount of oxygen or air to the desorbing step to burn some of the hydrogen and provide enough heat for desorption of the bulk of the hydrogen. Steam could be used to facilitate desorption either by providing heat and/or lowering the partial pressure of hydrogen, and can be removed from the hydrogen product by condensation. Since highly pure hydrogen can be retrieved in the desorption process at high pressure, part of or all of the hydrogen compression work for further processing could be eliminated.

Using two or more reactor vessels, one can either circulate the sorbent/catalyst materials between two fluidized bed reactors or the feed inlet to fixed bed reactors can be switched between feed gas (e.g. hydrocarbon feed stock/steam) and no gas (or oxygen or steam for heat supply) in order to remove the hydrogen stored.

Potential

The following study has been performed to evaluate the potential of a hydrogen sorption enhanced steam reformer according to the present invention.

A simple thermodynamic evaluation has been done to check if sorption heat could supply all the heat needed for the endothermic steam reforming reaction in a hydrogen sorption enhanced steam reformer (HSESR) reactor. The following relationship was used:

Cₚ*ΔT=ΔHₛₒᵣₚₜᵢₒₙ+ΔH_{reacton}

Cₚ for a feed with steam/C=3 and 30 bar as a function of temperature was found using the process simulation software Aspen HYSYS version 2004.2.

ΔH_{reaction} is ΔH₂₉₈ for the reaction CH₄+2H₂O=CO₂+4H₂ multiplied with t conversion.

FIG. 5 shows the pre-heat temperature needed to assure an outlet temperature of 500° C. or 800° C. in an adiabatic reactor using a hydrogen sorbent with varying sorption heat and a steam to carbon ratio of 3. Hydrogen recovery is 95%. The figure shows that the need of pre-heating is lowered when introducing a hydrogen sorbent into the reaction zone (sorption heat=0 is equivalent to no sorbent). It can also be seen from this figure that a material with a sorption heat of −43 to −44 kJ/mol H₂ is needed to balance the heat of reaction (i.e. pre-heat temperature equals outlet temperature) when the hydrogen recovery is 95%. A lower hydrogen recovery will give a higher needed absorption heat pr. mol H₂, since less hydrogen is absorbed. In this simple calculation, no heat losses (or heat needed for reduction of catalyst) are accounted for. Thus, the real sorption heat needed may be somewhat higher. As an example, Mg based hydrides have ΔH values between −60 and −80 kJ/mol H₂ see A. Reiser et al., Int. J. of Hydrogen Energy 25 (2000) 425-430. If too much heat is evolved from the sorption, cooling of the reactor could be needed.

A HYSYS model has been developed to simulate a HSESR process in more detail. The model consist of a pre-reformer (adiabatic Gibbs' reactor) with an inlet temperature of 500° C. and alternating heated Gibbs' reactors and hydrogen splits to simulate the HSESR reactor unit. The temperature can be varied (but is set equal in all streams and reactors after the pre-reactor). The heat needed to keep this temperature is used to calculate a minimum value for the sorption heat to supply the endothermic steam reforming reaction. No heat losses are included. The model uses (Norwegian) natural gas as feedstock.

TABLE 1
Results from the HYSYS model showing the increase in conversion
and the estimated needed heat of sorption with varying temperature
and plateau pressure.
Total pressure is 30 bar, steam/C. = 3.

| | | | | | Heat of |
|---|---|---|---|---|---|
| | | Conversion | Conversion | | sorption |
| Tem- | Plateau | without | with | Hydrogen | needed |
| perature | pressure | sorbent | sorbent | recovery | [kJ/mol |
| [° C.] | [bar] | [%] | [%] | [%] | H₂ absorbed] |
| 550 | 0.5 | 22.1 | 95.0 | 97.1 | 44.8 |
| 600 | 0.5 | 28.3 | 100.0 | 99.0 | 44.1 |
| 650 | 0.5 | 36.0 | 100.0 | 99.1 | 44.4 |
| 550 | 1.0 | 22.1 | 87.2 | 95.4 | 45.4 |
| 600 | 1.0 | 28.3 | 99.1 | 97.5 | 45.2 |
| 650 | 1.0 | 36.0 | 99.9 | 98.1 | 45.2 |
| 550 | 2.0 | 22.1 | 68.2 | 90.1 | 47.0 |
| 600 | 2.0 | 28.3 | 89.7 | 93.7 | 47.2 |
| 650 | 2.0 | 36.0 | 98.5 | 95.6 | 47.1 |

From table 1 it can be seen that the effect on the conversion and the hydrogen recovery is greatest using sorbents with a low plateau pressure. The estimated needed heat of sorption increases with an increasing plateau pressure. Further representations of the results using the HYSYS model are given in FIGS. 6 and 7.

As can be seen from FIG. 6, the addition of a hydrogen sorbent to the reaction zone can dramatically enhance the conversion. The effect is more pronounced when the sorbent material has a low hydrogen equilibrium pressure (e.g. plateau pressure of a metal hydride). At low temperatures the partial pressure of hydrogen never exceeds the hydrogen equilibrium pressure of the sorbent. Since only model sorbents have been considered, the hydrogen sorption below the assumed equilibrium pressure is not included in the present HYSYS-model, and therefore no effect of the sorbent can be seen in the figure at low temperature and high equilibrium pressure. In reality, the sorbent will have a small, positive effect on the conversion even in this range.

One line in this plot does not represent a specific sorption material, as the plateau pressure will change with temperature, not be constant as here.

Normally, increasing the reaction pressure will decrease the conversion in a steam reformer (see the grey line in FIG. 7). Even though, most steam reformers are run under pressures around 20-40 bar to reduce equipment size and minimize the need for later compression work. The disadvantage of high pressure could be overcome in a HSER, as the conversion actually increases with pressure when a hydrogen sorbent is added. At low reaction pressures the partial pressure of hydrogen may never exceed the hydrogen equilibrium pressure/plateau pressure of the sorbent. Since only model sorbents have been considered, the hydrogen sorption below the assumed equilibrium pressure is not included in the present HYSYS-model, and therefore no effect of the sorbent can be seen in the figure at low reaction pressure and high equilibrium pressure. In reality, the sorbent will have a small, positive effect on the conversion even in this range.

1. Method for production of hydrogen comprising reforming of a carbon comprising fuel thereby obtaining syngas, characterised in that wherein said method comprises
bringing the syngas in contact with a hydrogen sorption material,
ab-/adsorbing hydrogen in the hydrogen sorption material,
forming a CO₂ rich rest gas stream, and
desorbing hydrogen from said hydrogen sorption material, where the ab-/adsorbing of hydrogen enhances the production of hydrogen and carbon_dioxide.

2. Method according to claim 1, wherein the reforming is performed in proximity of a reforming catalyst.

3. Method according to claim 1 wherein sorption is performed in a first mode of operation and desorption is performed in a second mode of operation and the method further comprises operating in cycles between the two modes of operation.

4. Method according to claim 1 wherein sorption is performed in a first reactor and [[that]] the method further comprises transferring said sorption material from said first reactor to a second reactor wherein said desorption is performed.

5. Method according to claim 1 further comprising bringing the syngas in contact with a water gas shift catalyst.

6. Method according to claim 1 further comprising
optionally partly removing water from said rest gas stream, and
burning the rest gas stream at atmospheric or elevated pressure and thereby obtaining heat for the reforming and/or desorption.

7. Method according to claim 1, further comprises comprising burning a part of the desorbed hydrogen thereby obtaining heat for the reforming and/or desorption.

8. Method according to claim 1, wherein said reforming is performed in proximity of said hydrogen sorption material.

9. Method according to claim 8, wherein said reforming is performed in proximity of a water gas shift catalyst.

10. Method according to claim 1, wherein said reforming comprises steam reforming.

11. Method according to claim 1 wherein said reforming comprises autothermal reforming.

12. Method according to any claim 1, wherein the method further comprises upstream prereforming.

13. Method according to claim 1 wherein a temperature during the sorption is in the range 100 to 1000° C., preferably 200 to 800° C., more preferably between 300 and 650° C., even more preferably between 350 and 550° C.

14. Method according to claim 1 wherein a pressure during the sorption is between 2 and 150 bar, preferably between 15 and 80 bar, more preferably between 20 and 50 bar.

15. Method according to claim 1, wherein a temperature during the desorption is 10-400° C. above the temperature during the sorption, preferably between 50 and 250° C. above.

16. Method according to claim 1, wherein a pressure during the desorption is lower than during sorption, preferably less than 50%, more preferable less than 20% of the pressure during sorption.

17. Hydrogen production plant comprising at least one hydrogen enhanced sorption water gas shift reactor comprising a water gas shift catalyst and a hydrogen sorption material, wherein said hydrogen sorption water gas shift reactor comprises a syngas inlet, a rest gas/hydrogen outlet or a rest gas and a hydrogen rich sorption material outlet and optionally a sorption material inlet.

18. Hydrogen production plant according to claim 17, wherein the plant comprises at least two hydrogen sorption water gas shift reactors, working in swing operation for continuously production of hydrogen.

19. Hydrogen production plant according to claim 17, the plant further comprising a desorption reactor with a sorption material inlet in communication with said hydrogen rich sorption material outlet, a hydrogen outlet and a hydrogen depleted sorption material outlet in communication with said sorption material inlet.

20. Hydrogen production plant according to claim 17, wherein the plant further comprises a reformer with one or more inlets for carbon comprising fuel, steam and optionally an oxygen comprising stream and a syngas outlet in communication with said syngas inlet.

21. Hydrogen production plant according to claim 17, wherein the plant further comprises a condenser with a rest gas inlet in communication with said rest gas outlet and a water outlet and a dried rest gas outlet.

22. Hydrogen production plant according to claim 20, wherein the plant further comprises a combustor for burning the rest gas for heating the reformer or desorption.

23. Hydrogen production plant comprising at least one hydrogen sorption enhanced reformer comprising a hydrogen sorption material and a reforming catalyst wherein said reformer comprises one or more inlets for carbon comprising fuel, steam and optionally an oxygen comprising stream, and optionally a sorption material inlet; a rest gas/hydrogen outlet or a rest gas and a hydrogen rich sorption material outlet.

24. Hydrogen production plant according to claim 23, wherein the plant comprises at least two hydrogen sorption reformers, working in swing operation for continuous production of hydrogen.

25. Hydrogen production plant according to claim 23, further comprises further comprising a desorption reactor with a sorption material inlet in communication with said hydrogen rich sorption material outlet, a hydrogen outlet and a hydrogen depleted sorption material outlet in communication with said sorption material inlet.

26. Hydrogen production plant according to claim 23, wherein the at least one hydrogen sorption reformer further comprises a water gas shift catalyst.

27. Hydrogen production plant according to claim 23, wherein the plant further comprises a condenser with a rest gas inlet in communication with said rest gas outlet and a water outlet and a dried rest gas outlet.

28. Hydrogen production plant according to claim 23, wherein the plant further comprises a combustor for burning the rest gas for heating the reformer or desorption.

29. Reformer comprising one or more inlets for carbon comprising fuel, steam and optionally an oxygen comprising stream, the reformer comprising a hydrogen sorption material and a reforming catalyst, a rest gas/hydrogen outlet or a rest gas outlet and a hydrogen rich sorption material outlet.

30. Reformer according to claim 29, wherein said reformer further comprises a water gas shift catalyst.

31. Water gas shift reactor comprising a water gas shift catalyst and a syngas inlet, said reactor comprises a hydrogen sorption material and wherein the reactor comprises a rest gas/hydrogen outlet or a rest gas outlet and a hydrogen rich sorption material outlet.

32. Method for production of hydrogen from syngas, wherein the method comprises
bringing the syngas in contact with a hydrogen sorption material, in proximity of a water gas shift catalyst,
ab-/adsorbing hydrogen in the hydrogen sorption material,
forming a CO₂ rich rest gas stream, and
desorbing hydrogen from said hydrogen sorption material.
